(19) United States
(12) Patent Application Publication
(10) Pub. No.: US 2011/0289657 A1
(43) Pub. Date: Dec. 1, 2011

(54) SPECIALIZED SOCK HAVING REMOVEABLE INSERT

(76) Inventor: Charles Starr, Marshalltown, IA (US)

(21) Appl. No.: 11/944,069

(22) Filed: Nov. 21, 2007

Related U.S. Application Data
(60) Provisional application No. 60/867,698, filed on Nov. 29, 2006.

(51) Int. Cl. A43B 17/00; B23P 11/00

(52) U.S. Cl. 2/240; 29/428

(57) ABSTRACT

A specialized sock having a removable insert. The specialized sock includes an upper leg region with a sock opening leading to a sock interior, a bottom sock section, and an upper sock section. The sock also includes a liner mounted within the interior of the sock. The liner is positioned along the upper leg region and the bottom section and has an opening adjacent the sock opening. An insert sized and shaped to fit against a bottom of a foot of a user is inserted through the insert opening and positioned adjacent the bottom section of the sock. The specialized sock allows a person to utilize an insert without wearing a shoe. The specialized sock also allows the user to easily and quickly insert and remove the insert from the specialized sock.

### RELATED APPLICATIONS

This utility application claims the benefit of U.S. Provisional Patent Application Ser. No. 60/867,698 by Charles E. Starr, filed Nov. 29, 2006, and is hereby incorporated by reference.

### BACKGROUND OF THE INVENTION

1. Field of the Invention

This invention relates to footwear accessories. Specifically, and not by way of limitation, the present invention relates to a specialized sock having a removable interiorly mounted insert.

2. Description of the Related Art

The human foot is resilient and extremely important in maintaining the mobility of an individual. However, although the foot is strong and resilient, it is subjected to substantial stresses, resulting in pain to the individual. There are currently many inserts which are used within an interior of a shoe, ranging from odor eliminating inserts, arch supports and cushion soles to eliminate or alleviate foot pain. However, although these inserts are very useful in conjunction with the wearing of shoes, the inserts are not useable outside of a shoe. There are many situations, such as in one's home, that shoes are not necessary. Additionally, the wear of shoes can be uncomfortable and, at times, painful and a detriment to the health of a person's feet. Thus, a specialized sock is needed which enables the use of an insert without significantly modifying a sock.

Although there are no known prior art teachings of an apparatus such as that disclosed herein, prior art references that discusses subject matter that bears some relation to matters discussed herein are U.S. Pat. No. 6,230,525 to Dunlap (Dunlap), U.S. Pat. No. 6,880,268 to Chen (Chen), and U.S. Pat. No. 6,292,951 to Kalde.

Dunlap discloses a sock having a sole which provides increased comfort, impact absorption, and abrasion resistant. The sock disclosed in Dunlap is knit with conventional yarns and a certain restricted elongation covered elastomeric yarn. However, Dunlap does not disclose a removable sole positioned within the interior of a sock.

Chen discloses a sock combined with an insole. The insole is formed with elastic hooks having elastic hooks. The hooks are deformed due to an external force, but are restored when the force is removed. Chen also discloses a sock have a sock sole with curl wires for grasping the hooks so that the sock is tightly secured to the insole to prevent the relative motion between the sock and the insole. However, Chen does not disclose a sock having an interior liner for holding a removable insert in place within the sock. Chen suffers from the disadvantage of using hooks and curl wires, which are costly, complicated and impose undue stress upon the sock.

Kalde discloses a sock having a reinforced toe area, a reinforced heel region and a reinforced sole region between the toe and heel regions. The reinforced sole region is contoured to a foot sole surface. However, Kalde does not teach or suggest a removable insert.

Accordingly, it would be advantageous to have a sock having a removable insert which is economical, easy to use and requires minimal modifications to the sock. It is an object of the present invention to provide such an apparatus.

### SUMMARY OF THE INVENTION

In one aspect, the present invention is a specialized sock having a removable insert. The specialized sock includes an upper leg region with a sock opening leading to a sock interior, a bottom sock section, and an upper sock section. The sock also includes a liner mounted within the interior of the sock. The liner is positioned along the upper leg region and the bottom section and has an opening adjacent the sock opening. An insert sized and shaped to fit against a bottom of a foot of a user is inserted through the insert opening and positioned adjacent the bottom section of the sock.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a side view of a specialized sock in the preferred embodiment of the present invention;

FIG. 2 is a side view of a removable insert removed from the specialized sock;

FIG. 3 is a side view showing a partial interior view of the sock with the insert positioned within the specialized sock;

FIG. 4 is a top view of the upper leg region, the sock opening and the insert opening of the specialized sock of FIG. 1;

FIG. 5 (prior art) is a side view of a convention sock; and

FIG. 6 is a side view of the conventional sock cut along the cutting line depicted in FIG. 5.

### DESCRIPTION OF THE INVENTION

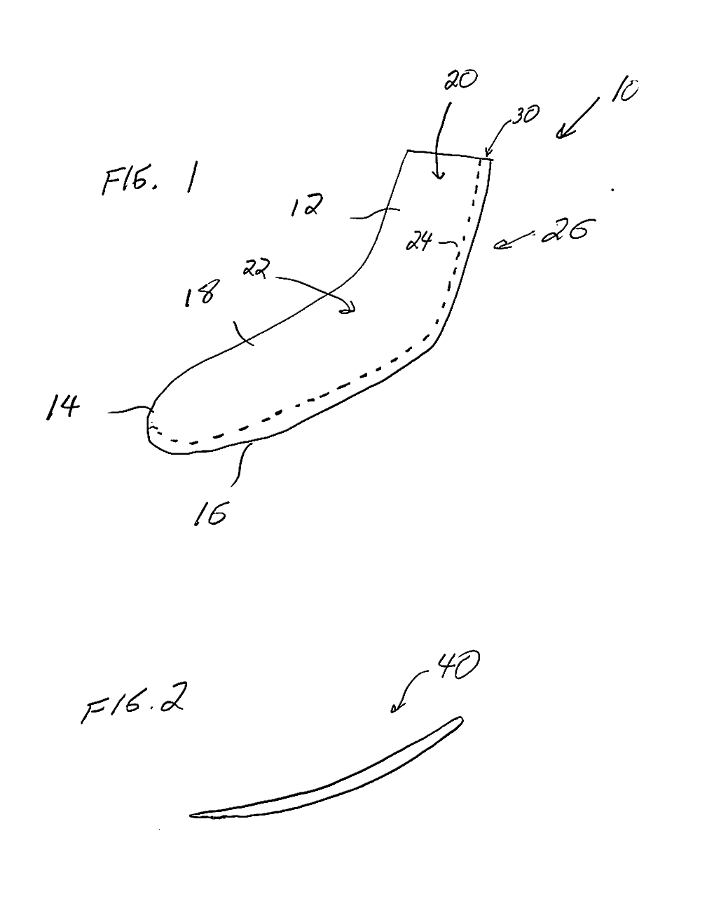

A specialized sock having a removable insert is disclosed. FIG. 1 is a side view of a specialized sock 10 in the preferred embodiment of the present invention. The sock includes an upper leg region 12, a toe region 14, a bottom section 16 and an upper section 18. The upper leg region is substantially tubular in shape and includes an opening 20 leading to a sock interior 22. The above-mentioned components of the sock 10 are similar to existing socks. However, the specialized sock 10 also includes an interiorly mounted insert liner 24 positioned within the sock interior 22 along a back portion 26 of the upper leg region and the bottom section 16. Between the insert liner 24 and the upper leg region 12 adjacent the opening 20 is an insert opening 30.

The specialized sock may be constructed of any conventional textile material suitable for a sock. Additionally, the insert liner 24 is preferably constructed of the same material as the remaining components of the specialized sock 10. However, in an alternate embodiment of the present invention, the insert liner may be constructed of another material different than the remaining portions of the specialized sock 10. Additionally, the sock may be any type of sock of any size, length, or shape.

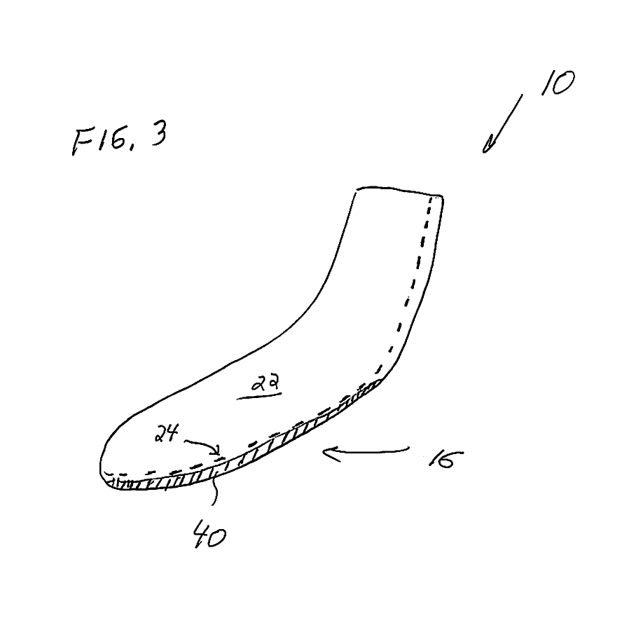

FIG. 2 is a side view of a removable insert 40 removed from the specialized sock 10. The removable insert is sized and shaped to fit and contour the bottom of a user's foot and fits within the bottom section 16 of the specialized sock. The removable insert may be any type of insert, such as those inserts commonly used in shoes (e.g., cushion inserts, support inserts, etc.).

FIG. 3 is a side view showing a partial interior view of the sock with the insert 40 positioned within the specialized sock 10. The insert 40 is positioned between the insert liner 24 and the bottom section 16 of the sock. The user's foot is inserted within the sock interior 22 and rests upon the top of the liner and the insert. The insert 24 is held in place by the force of the user's foot.

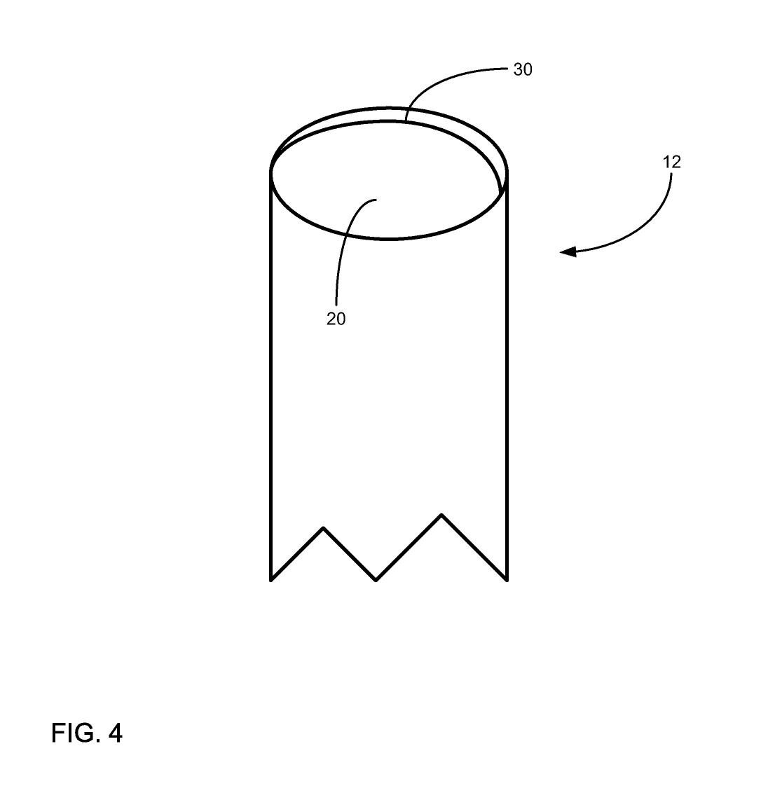

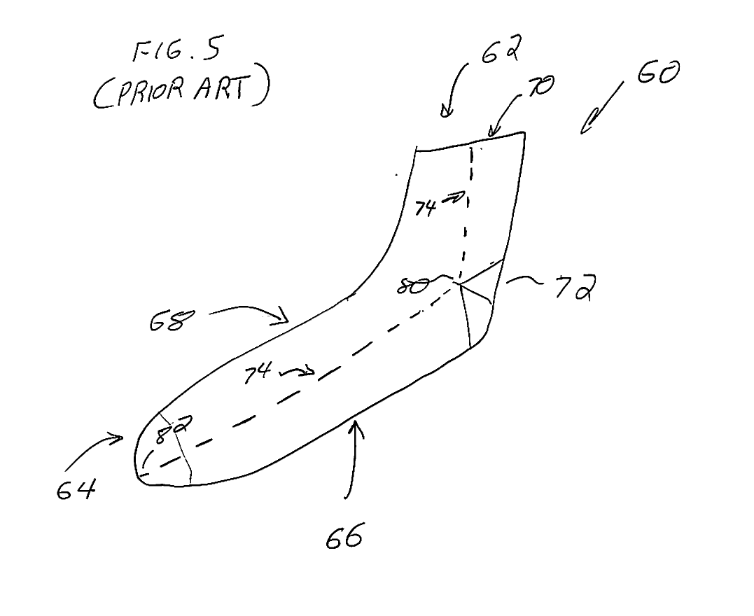

FIG. 4 is a top view of the upper leg region 12, the sock opening 20 and the insert opening 30. The insert liner lies adjacent the back portion 26 of the upper leg region 14. The liner opening is sized to allow insertion of the removable insert 40 into the sock interior 22, between the liner 24 and the upper leg region 12. The insert is then slid down to the bottom section 16 of the sock.

The specialized sock 10 may be constructed in various ways. In one embodiment, a conventional sock may be used for constructing the insert liner 24. FIG. 5 is a side view of a convention sock 60. The conventional sock includes an upper leg region 62, a toe region 64, a bottom section 66, an upper section 68, an opening 70, and a heel region 72. FIG. 5 illustrates a cutting line 74 starting from the center of the upper section 68 at the opening 70 to an intersection point 80 located at the heel region 72. The cutting line 74 continues from the intersection point 80 to the toe region 64 at intersection point 82 (located between the bottom section 66 and the upper section 68).

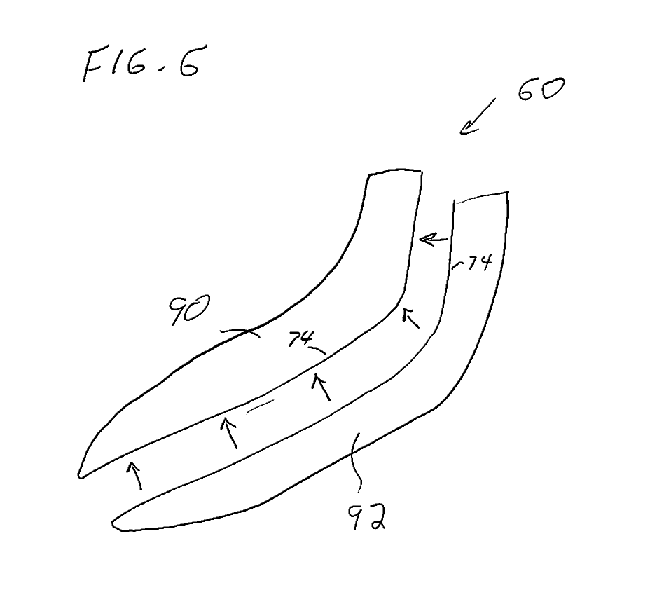

FIG. 6 is a side view of the conventional sock 60 cut along the cutting line 74. The conventional sock 60 is cut upon line 74, which runs on both sides of the conventional sock, thus dividing the conventional sock into a first upper cut section 90 and a lower cut section 92. The upper cut section 90 may be discarded. The lower cut section 92 is utilized as the insert liner 24.

In constructing the specialized sock 10, the specialized sock 10 is turned inside out. The lower cut section 92 is positioned against the bottom section 16, aligning the lower cut section 92 with the shape and position of the bottom section, thereby providing a contoured layout of the liner against the bottom section 16 and the upper leg region 12. The lower cut section 92 is then attached (preferably sewn) to the interior side of the specialized sock. The liner opening 30 located adjacent the sock opening 20 is left open to allow insertion of the insert 40 as desired by the user. Upon construction of the specialized sock, the specialized sock is turned back to its original position, with the liner 24 located on the interior of the sock. It should be understood by those skilled in the art that the liner may be constructed in any fashion and method.

With reference to FIGS. 1-4, the operation of the specialized sock 10 will now be discussed. When the user desires to use the specialized sock, the user may insert a desired insert 40 into the specialized sock by inserting the insert through the insert opening 30 located adjacent the sock opening 20. The insert is slid down into the interior 22 of the sock from the upper leg region 12 until the insert is positioned adjacent the bottom section 16, where the user's foot is located when wearing the specialized sock 10. The user's foot is then inserted within the interior of the specialized sock. The user's foot lies on top of the liner and the insert. The liner provides some massaging of the bottom of the user's foot. In addition, in conjunction with the liner, the force of the foot holds the insert 40 in place within the specialized sock 10. The user may then utilize the sock and insert without any shoes, thereby removing stress to the user's foot. Alternately, the user may don shoes to utilize the specialized sock with shoes. The user may remove the insert as desired to replace the insert or allow the washing of the sock separate from the insert.

The insert 40 is preferably inserted prior to placing the sock on the user's foot. However, in an alternate embodiment of the present invention, the insert may be easily inserted with the user wearing the shoe. The user may pull the upper leg region 12 down to the user's heel and easily insert the insert 24 through the insert opening 30 and position the insert 24 upon the bottom section 16 of the specialized sock.

The present invention provides many advantages over existing socks. The specialized sock 10 allows the use of inserts without having to wear shoes. In addition, the specialized sock holds the insert in place without costly or complicated modifications to an existing sock. Additionally, the liner provides an additional layer of cushion and comfort to the user. By utilizing the liner, undue stress in constructing and wear of the sock is minimized. The liner also eliminates the need for fasteners, which are costly and may cause discomfort to the user. Additionally, the present invention provides an insert opening allowing ease in insertion and removal of the insert.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

What is claimed is:

1. A specialized sock having a removable insert, the specialized sock comprising:
a sock having an upper leg region with a sock opening leading to a sock interior;
a bottom sock section;
an upper sock section;
a liner mounted within the interior of the sock, the liner being positioned along the upper leg region and the bottom section and having an opening adjacent the sock opening; and
an insert sized and shaped to fit against a bottom of a foot of a user;
whereby the insert is inserted through the insert opening and positioned adjacent the bottom section of the sock.

2. The specialized sock having a removable insert of claim 1 wherein the liner is constructed of the same material as the sock.

3. The specialized sock having a removable insert of claim 1 wherein the insert is constructed of a cushion material.

4. The specialized sock having a removable insert of claim 1 wherein the insert provides foot support.

5. The specialized sock having a removable insert of claim 1 wherein the liner is attached to an interior portion of a conventional sock.

6. A specialized sock having a removable insert, the specialized sock comprising:
a conventional sock, the conventional sock having:
an upper leg region with a sock opening leading to a sock interior;
a bottom sock section;
an upper sock section;
a liner constructed from a second conventional sock, the second convention sock having a bottom sock section and an upper sock section, wherein the bottom sock section is removed from the second conventional sock for use as the liner;
wherein the liner is mounted within the interior of the sock, the liner being positioned along the upper leg region and the bottom section and having an opening adjacent the sock opening; and
an insert sized and shaped to fit against a bottom of a foot of a user;
whereby the insert is inserted through the insert opening and positioned adjacent the bottom section of the sock.

7. The specialized sock having a removable insert of claim 6 wherein the liner is constructed of the same material as the sock.

8. The specialized sock having a removable insert of claim 6 wherein the insert is constructed of a cushion material.

9. The specialized sock having a removable insert of claim 6 wherein the insert provides foot support.

10. The specialized sock having a removable insert of claim 6 wherein the liner is attached to a conventional sock.

11. A method of construction a specialized sock having a removable insert, the method comprising the steps of:
cutting a bottom sock section from a first conventional sock, the cut bottom sock section being a liner;
attaching the liner to an interior of a second conventional sock, the second conventional sock having an upper leg region with a sock opening leading to the sock interior, a bottom sock section, and an upper sock section;
wherein the liner is attached within the interior of the sock, the liner being positioned along the upper leg region and the bottom section and having an opening adjacent the sock opening; and
inserting an insert through the insert opening and positioned adjacent the bottom section of the sock, the insert being sized and shaped to fit against a bottom of a foot of a user.
